(19) United States
(12) Patent Application Publication
(10) Pub. No.: US 2006/0096157 A1
(43) Pub. Date: May 11, 2006

(54) Colored flame candle

(76) Inventor: Tatsuya Suzuki, Narashino-shi (JP)

Correspondence Address: Tatsuya Suzuki, 7-7-62-307, Yatsu, Narashino-shi, Chiba, JP

(21) Appl. No.: 10/984,714

(22) Filed: Nov. 10, 2004

(51) Int. Cl. C11C 5/00

(52) U.S. Cl. 44/275

(57) ABSTRACT

In a candle having a colored flame using a flame reaction, a fault of a conventional candle, that is, only an upper part of the flame is colored, is solved by using an alkali metal salt of trifluoroacetylacetone or hexafluoroacetylacetone, an alkaline earth metal salt of trifluoroacetylacetone or hexafluoroacetylacetone and an aluminum group element salt of trifluoroacetylacetone or hexafluoroacetylacetone as a substance giving a flame reaction, and most or all of the flame can be colored. Further, the strength of the candle can be increased by mixing at least one of threitol, xylitol and iditol into the solid fuel substance, without influencing to colorability of the flame.

### BACKGROUND OF THE INVENTION

1. Field of the Invention

The present invention relates to a candle, in which the flame can be changed in various colors by a flame reaction.

2. Description of the Conventional Art

In a conventional candle using paraffin, the yellow light resulting from the production of soot accounts for most of the flame, and any red or blue colors are obliterated by the yellow, resulting in that it is impossible to produce the desired hues, which is a fault of these conventional candles. For solving this fault, it is considered that the method comprises, making a light blue flame made by complete combustion of a candle, and coloring this flame by a flame reaction. When a solid fuel substance comprising molecules having a high content ratio of oxygen atom to carbon atom is used, the light blue flame can be generated by complete combustion. When this light blue flame reacts with the substance giving flame reaction, it is considered that the flame having the desired color can be theoretically generated.

Based on the above consideration, searching for a suitable solid fuel substance was carried out. For example, following materials are considered as a candidate of the solid fuel substance, that is, polyethylene glycol, trioxane, ethyl carbamate, monomethyl succinate, dimethyl oxalate, trimethyl citrate or the like. However, as for the red color, the candle in which most or all of the flame is colored cannot be realized.

As the substance giving flame reaction, following materials are used, that is, a chloride of an alkali metal or an alkaline earth metal, a nitrate of an alkali metal or an alkaline earth metal, an alkali metal salt of fatty acid, an alkali metal salt of acetylacetone, or the like. However, as for red color, all of the flame cannot be colored.

The candles using the above solid fuel substances except polyethylene glycol have a fault whose strength is low as compared with the conventional candle using the paraffin as the solid fuel substance. In order to avoid this, in the candle disclosed in U.S. Pat. No. 6,712,865, higher fatty acid triglyceride is mixed into the solid fuel substance, but it has a fault that the flame is mixed with the yellow light since higher fatty acid triglyceride has low content of oxygen atom.

The present invention has an object to provide a candle where most or all of the flame is colored while maintaining sufficient burning and the strength is not lowered. This candle is colored by a flame reaction and prevents the conventional fault of the candle, that is, only the upper part of the flame is colored.

### SUMARRY OF THE INVENTION

In the conventional candle using dimethyl oxalate or trimethyl citrate as a solid fuel substance, only the upper part of the flame is colored with respect to make the red color flame. However, in the candle according to the present invention, most or all of the flame can be colored by using an alkali metal salt of trifluoroacetylacetone or hexafluoroacetylacetone, an alkaline earth metal salt of trifluoroacetylacetone or hexafluoroacetylacetone, or an aluminum group element salt of trifluoroacetylacetone or hexafluoroacetylacetone, as the substance giving the flame reaction. The strength of the candle can be increased by mixing at least one of threitol, xylitol or iditol, without influencing to colorability of the flame.

### DETAILED DESCRIPTION OF PREFERRED EMBODIMENT

While advancing research, the reason that the only upper part of the flame is colored in the conventional candle was found. That is, since the boiling point of the substance giving the flame reaction is remarkably higher than the boiling point or the decomposition temperature of the solid fuel substance, the substance giving the flame reaction is boiled or its volatility is increased at the upper part. So, the only upper part of the flame is colored.

Therefore, it is necessary for coloring of all of the flame that the boiling point or the decomposition temperature of the solid fuel substance is high, or the boiling point of the substance giving the flame reaction is low. Therefore, it is necessary to search a suitable combination of the solid fuel substance and the substance giving the flame reaction. However, the boiling point or the decomposition temperature of the solid fuel substance is limited at about 300° C., and thus a method for lowering the boiling point of the flame reaction substance is especially needed.

For making the red color flame, an acetylacetone lithium salt showing comparatively sufficient colorability in the conventional art is mixed into polyethylene glycol, trioxane, ethyl carbamate, monomethyl succinate, dimethyl oxalate, trimethyl citrate, trimethylolethane, pentaerythritol, dimethyl tartrate respectively. Among these materials, dimethyl oxalate and trimethyl citrate do not react with the acetylacetone lithium salt, and make a comparatively sufficient burning, for example, a sufficient size, shape or the like of the flame. However, only 50% of the upper part of the flame is colored even when each material is used respectively.

For increasing colorability of red color, it was tried that alkali metal salts of trifluoroacetylacetone and hexafluoroacetylacetone were used as the substance giving the flame reaction. Trifluoroacetylacetone and hexafluoroacetylacetone were made by substituting hydrogen of methyl groups in acetylacetone with fluorine to increase volatilities. For example, although only 50% of the upper part of the flame is colored red when trifluoroacetylacetone lithium salt is mixed into dimethyl oxalate, 70% of the upper part of the flame can be colored red when hexafluoroacetylacetone lithium salt is mixed into dimethyl oxalate, and thus practically sufficient coloring can be obtained.

Then, the lithium salts of trifluoroacetylacetone and hexafluoroacetylacetone are mixed into the trimethyl citrate having a higher decomposition temperature than the boiling point of the dimethyl oxalate respectively. When the trifluoroacetylacetone lithium salt is mixed, 70% of the flame is colored and when the hexafluoroacetylacetone lithium salt is mixed, all of the flame can be colored, and thus the sufficient colorability can be obtained.

As mentioned above, when the alkali metal salt of trifluoroacetylacetone or hexafluoroacetylacetone is mixed into trimethyl citrate, it is remarkably effective to increase the colorability of the flame. In the case of a sodium salt (yellow color flame), a potassium salt (red-purple color flame), a rubidium salt (red color flame), a cesium salt (blue-purple color flame), the same effects as the case of the lithium salt can be obtained. Furthermore, when the alkaline earth metal salt of trifluoroacetylacetone or hexafluoroacetylacetone, or an aluminum group element salt of trifluoroacetylacetone or hexafluoroacetylacetone is mixed into trimethyl citrate, it is remarkably effective to increase the colorability of the flame. In the cases of a calcium salt (orange color flame), a strontium salt (red color flame), a barium salt (green color flame), an aluminum salt (indigo-blue color flame), a gallium salt (purple color flame) and an indium salt (indigo-blue color flame), almost or all of the flame can be colored.

As for the substance giving the flame reaction, two methods can be carried out, that is, the method adhering the substance to the wick, and the method mixing the substance into the solid fuel substance. However, the method mixing the substance into the solid fuel substance is preferable from the point of stability of burning.

When the substance giving the flame reaction is mixed into the solid fuel substance, the substance giving the flame reaction is hardly solved in dimethyl oxalate, trimethyl citrate or the like, and thus it is necessary to disperse the substance giving the flame reaction in the solid fuel substance by using a suitable solvent. Although ethylene glycol, glycerol, acetamide or the like can be used as the solvent, these solvents have faults that the strength of the solidified candle is lowered. Then, a sugar alcohol is used as the solvent. It is found out that erythritol, mannitol, sorbitol or the like among the sugar alcohol cannot be used since easily reacting with the substance giving the flame reaction. It is found out that threitol, xylitol or iditol hardly reacts with the substance giving the flame reaction, and remarkably increases the strength of the solidified candle. Thereby, the higher strength than that of the conventional paraffin candle can be obtained. The yellow light is mixed into the flame when higher fatty acid triglyceride is mixed. However, the yellow light is not mixed into the flame when threitol, xylitol or iditol is mixed because they have the high content of oxygen atom.

Hereinafter, examples are shown. In addition, all mixing ratio in examples are shown as % by mass.

### EXAMPLE 1

The mixing ratio of the candle in Example 1 is as follow, where dimethyl oxalate is used as the solid fuel substance and the alkali metal salt of hexafluoroacetylacetone is mixed as the substance giving the flame reaction.

| | |
|---|---|
| Dimethyl oxalate | 75% |
| Ethylene glycol | 20% |
| Hexafluoroacetylacetone lithium salt | 5% |

The candle is molded by dissolving hexafluoroacetylacetone lithium salt in the ethylene glycol, adding and dissolving the dissolved substance to the melted dimethyl oxalate, and casting it into a predetermined mold. As for the candle molded in this way, since 70% of the upper part of the flame is colored red, the practically sufficient colorability can be obtained, and the sufficient burning state is maintained. Furthermore, as the substance giving the flame reaction, the following materials may be used instead of hexafluoroacetylacetone lithium salt as mentioned above, that is, the alkali metal salt of hexafluoroacetylacetone other than hexafluoroacetylacetone lithium salt, the alkaline earth metal salt of hexafluoroacetylacetone, or the aluminum group element salt of hexafluoroacetylacetone.

### EXAMPLE 2

The mixing ratio of the candle in Example 2 is as follow, where trimethyl citrate is used as the solid fuel substance, the alkali metal salt of hexafluoroacetylacetone is mixed as the substance giving the flame reaction, and xylitol is also mixed as the solvent of the substance giving the flame reaction.

| | |
|---|---|
| Trimethyl citrate | 85% |
| Xylitol | 12% |
| Hexafluoroacetylacetone lithium salt | 3% |

The candle is molded by dissolving hexafluoroacetylacetone lithium salt in xylitol, adding and dissolving the dissolved substance to the melted trimethyl citrate, and casting it into the predetermined mold. As for the candle molded in this way, all of the flame is colored red, and the sufficient burning state is maintained. Furthermore, as the substance giving the flame reaction, the following materials may be used instead of hexafluoroacetylacetone lithium salt, that is, an alkali metal salt of hexafluoroacetylacetone other than hexafluoroacetylacetone lithium salt, an alkaline earth metal salt of hexafluoroacetylacetone, or an aluminum group element salt of hexafluoroacetylacetone. Furthermore, since xylitol is mixed, the strength of the candle can be remarkably increased. When threitol or iditol is used instead of xylitol, the same effect can be obtained. In addition, when the alkali metal salt of trifluoroacetylacetone, the alkaline earth metal salt of trifluoroacetylacetone or the aluminum group element salt of trifluoroacetylacetone is used, 70% of the flame is colored, and the practically sufficient colorability can be obtained.

What is claimed is:

1. A candle having a solid fuel substance, a wick and a substance giving a flame reaction,
wherein the substance giving the flame reaction including at least one selected from an alkali metal salt of hexafluoroacetylacetone, an alkaline earth metal salt of hexafluoroacetylacetone and an aluminum group element salt of hexafluoroacetylacetone is used as the substance giving the flame reaction.

2. The candle according to claim 1,
wherein at least one part of the solid fuel substance is dimethyl oxalate or trimethyl citrate.

3. A candle having a solid fuel substance, a wick and a substance giving a flame reaction,
wherein the substance giving the flame reaction including at least one selected from an alkali metal salt of trifluoroacetylacetone, an alkaline earth metal salt of trifluoroacetylacetone and an aluminum group element salt of trifluoroacetylacetone is used as the substance giving the flame reaction, and at least one part of the solid fuel substance is trimethyl citrate.

4. A candle having a solid fuel substance, a wick and a substance giving a flame reaction,
wherein at least one of threitol, xylitol and iditol is mixed into the solid fuel substance.

5. The candle according to claim 4,
wherein at least one part of the solid fuel substance is dimethyl oxalate or trimethyl citrate.
